(19) United States
(12) Patent Application Publication
(10) Pub. No.: US 2012/0201492 A1
(43) Pub. Date: Aug. 9, 2012

(54) OPTICAL BRANCHING ELEMENT AND OPTICAL BRANCHING CIRCUIT, AND MANUFACTURING METHOD THEREOF

(75) Inventor: Takashi Matsumoto, Tokyo (JP)

(73) Assignee: NEC CORPORATION, Tokyo (JP)

(21) Appl. No.: 13/500,839

(22) PCT Filed: Oct. 4, 2010
(86) PCT No.: PCT/JP2010/067709

§ 371 Date: Apr. 6, 2012

(30) Foreign Application Priority Data
Oct. 9, 2009 (JP) 2009-235112

(51) Int. Cl. G02B 6/28; B23Q 17/00

(52) U.S. Cl. 385/14; 385/24; 29/407.01

(57) ABSTRACT

Provided are an optical branching element and an optical branching circuit and a manufacturing method thereof, which have high production tolerance and capability of setting an optional optical branching rate, and are suitable for use in optical integrated circuits.

An optical branching element comprises a first and a second optical waveguides which are arranged in parallel to each other and have portions for optical coupling at at least two positions, wherein an optical path length difference is set between a portion of the first optical waveguide and a portion of said second optical waveguide both linking said portions for optical coupling, and values of respective branching rates of the portions for optical coupling are set at values in a combination giving a stationary state of variation in optical output from a branch side optical waveguide with respect to variation in the branching rates.

### TECHNICAL FIELD

The present invention relates to an optical branching element which constitutes an optical integrated circuit, and in particular to a structure and a manufacturing method which suppress variability in optical branching characteristics of an optical branching element.

### BACKGROUND ART

With recent progress in optical waveguide technology, practical implementation and large scale integration of optical circuits have been achieved. An optical branching element is one of key devices particularly in configuring optical integrated circuits.

In general, as optical branching elements, there are mentioned, for example, a Y-shaped optical branching waveguide, a multimode interferometer type. (hereinafter, referred to as “MMI type”) optical branching element, a directional coupler and a Mach-Zehnder interferometer type (hereinafter, referred to as “MZI type”) optical branching element. These optical branching elements can be produced by the use of thin film growth technology and microfabrication technology of semiconductor manufacturing processes.

Here, the Y-shaped optical branching waveguide is the one whose edge is branched in a Y-shape and shows excellent wavelength characteristics theoretically, but its production tolerance is low since microfabrication is required at a connection part with a branch optical waveguide.

The MMI type optical branching element branches light by the use of multi-mode interference, where a gap between two optical waveguides can be set wider, and accordingly a higher production tolerance can be given compared to the Y-shaped optical branching element. However, because there exist a connection between a single-mode waveguide and a multi-mode waveguide, the MMI type optical branching element cannot be free from mode conversion loss.

Further, with respect to the directional coupler type one, which is configured with two optical waveguides arranged close to each other, and the MZI type optical branching element, in which directional couplers are configured at two positions and two optical waveguides between the two directional couplers are configured to have different optical path lengths, there is production difficulty in stabilizing optical branching characteristics. This is because while the two waveguides need to be formed with an extremely narrow gap between them at the positions where the directional couplers are to be configured, current technology levels of photolithography and etching cannot provide sufficient accuracy to yield a stable value of an optical coupling coefficient κ of a directional coupler.

On the other hand, a large number of these optical branching elements are used in configuring an optical circuit, and therefore it is very important to suppress variability in an optical branching rate (or, optical branching ratio) of each optical branching element. Whereas optimization of photolithography to fabricate uniform waveguide widths and optimization of etching have been conducted until now, it is still difficult to achieve sufficient suppression of production variability. Accordingly, instead of relying on precision of production technology, development has been conducted on a technology which is focused on suppressing variability in an optical branching rate through a change in element configuration. For example, Japanese Patent Application Laid-Open No. 2001-318253 (hereinafter, referred to as “patent document 1”) describes a technology in which a directional coupler is formed using curved optical waveguides. It is mentioned there that as a length of a narrow gap portion becomes smaller in the configuration, production tolerance is that much improved. Further, Japanese Patent Application Laid-Open No. 2001-228348 (hereinafter, referred to as “patent document 2”) describes a technology where, by connecting 2×2 optical branching elements in cascade, a total optical branching rate can be made to converge to approximately 50% even when variability in an optical branching rate exists in each element. Still further, Japanese Patent Publication No. 2653883 (hereinafter, referred to as “patent document 3”) describes a technology where, by adjusting an optical path length difference between two optical waveguides linking two directional couplers constituting an MZI type optical branching element, variation in an optical branching ratio with wavelength is cancelled out. It is mentioned in patent document 3 that the technology makes it possible to keep an optical branching rate within a certain range over a wide range of wavelength.

### DISCLOSURE OF INVENTION

### Technical Problem

However, the above-mentioned optical branching elements have the following problems.

First, in the method described in patent document 1 where a directional coupler is configured with curved waveguides, a length of a narrow gap part is relatively reduced compared to when a directional coupler is configured with straight waveguides. However, in order to obtain a strong optical coupling, the waveguide gap needs to be smaller, and consequently higher processing accuracy is required locally. In addition, the method has a problem in that when curvature radii of the curved waveguides are increased and an effective optical coupling length is thereby increased so as to obtain a strong optical coupling, the element becomes large in its whole size and thus becomes unsuitable for application to optical integrated circuits.

In the method of patent document 2 where 2×2 optical branching elements are connected in cascade, it is possible to converge an optical branching rate to 50% by arranging the optical branching elements in a multiple stage form. However, a problem arises in that a value of an optical branch rate is fixed only at 50% and any other optional value cannot be achieved.

Further, with respect to the MZI type optical branching element of patent document 3, it is mentioned that, by suppressing variation in a branching rate with wavelength characteristics, the optical branching rate can be kept within a certain range over a wide range of wavelength. However, this technology cannot suppress variation in a branching rate due to production variability itself of a directional coupler constituting the optical branching element. Accordingly, this optical branching element has a problem in that, while relative variation in an optical branching rate with respect to wavelength could be suppressed, a set value of a branching rate itself cannot be obtained stably.

The objective of the present invention is to solve the problems described above, and thus provide an optical branching element and an optical branching circuit and a manufacturing method thereof which have a high production tolerance and capability of setting an optional optical branching rate value and are suitable for use in optical integrated circuits.

### Solution to Problem

An optical branching element of the present invention comprises a first and a second optical waveguides which are arranged in parallel to each other and have portions for optical coupling (that is, portions where the two waveguides optically couples with each other) at at least two positions, and is characterized by that an optical path length difference is set between a portion of the first optical waveguide and a portion of the second waveguide both linking the aforementioned portions for optical coupling, and by that values of respective branching rates of the portions for optical coupling are set at values in a combination giving a stationary state of variation in an optical output from the branch side optical waveguide (that is, a coupled output) with respect to variation in the branching rates.

Further, a manufacturing method of an optical branching element of the present invention is a manufacturing method of an optical branching element comprising a first and a second optical waveguides which are arranged in parallel to each other and have portions for optical coupling at at least two positions, and is characterized by that an optical path length difference is set between a portion of the first optical waveguide and a portion of the second waveguide both linking the aforementioned portions for optical coupling, and by that values of respective branching rates of the portions for optical coupling are set at values in a combination giving a stationary state of variation in an optical output from the branch side optical waveguide with respect to variation in the branching rates.

### Advantageous Effects of Invention

According to the present invention, an optical branching element and an optical branching circuit are obtained which have a high production tolerance and capability of setting an optional optical branching ratio and are suitable for use in optical integrated circuits.

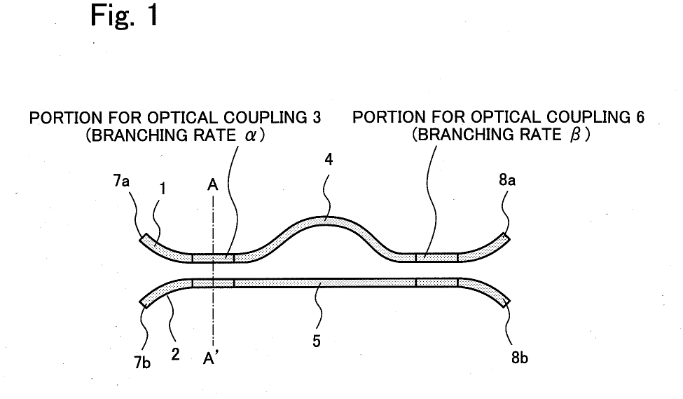

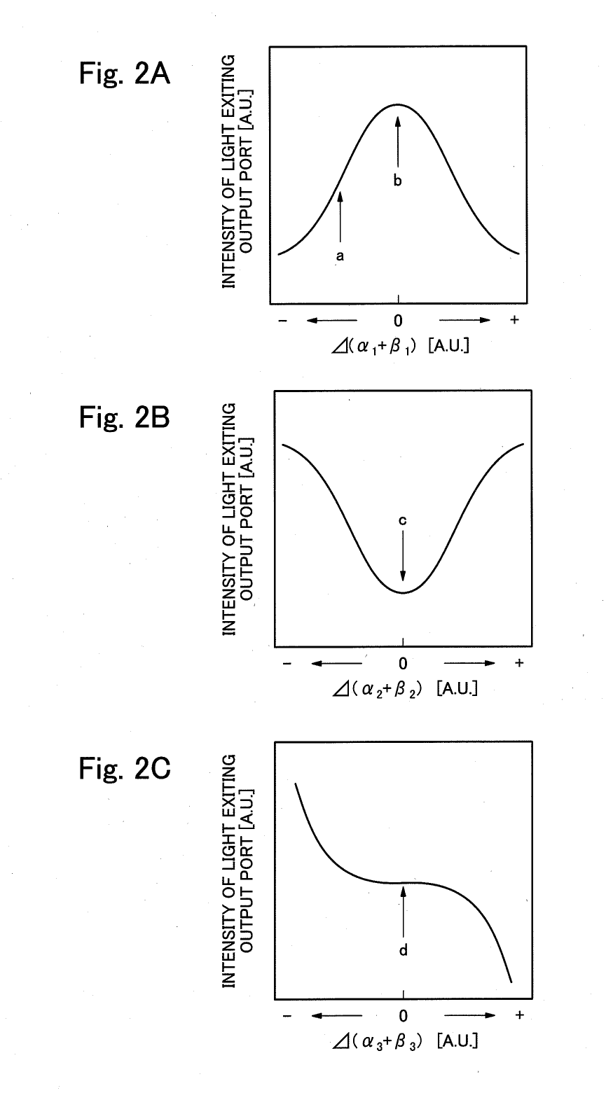

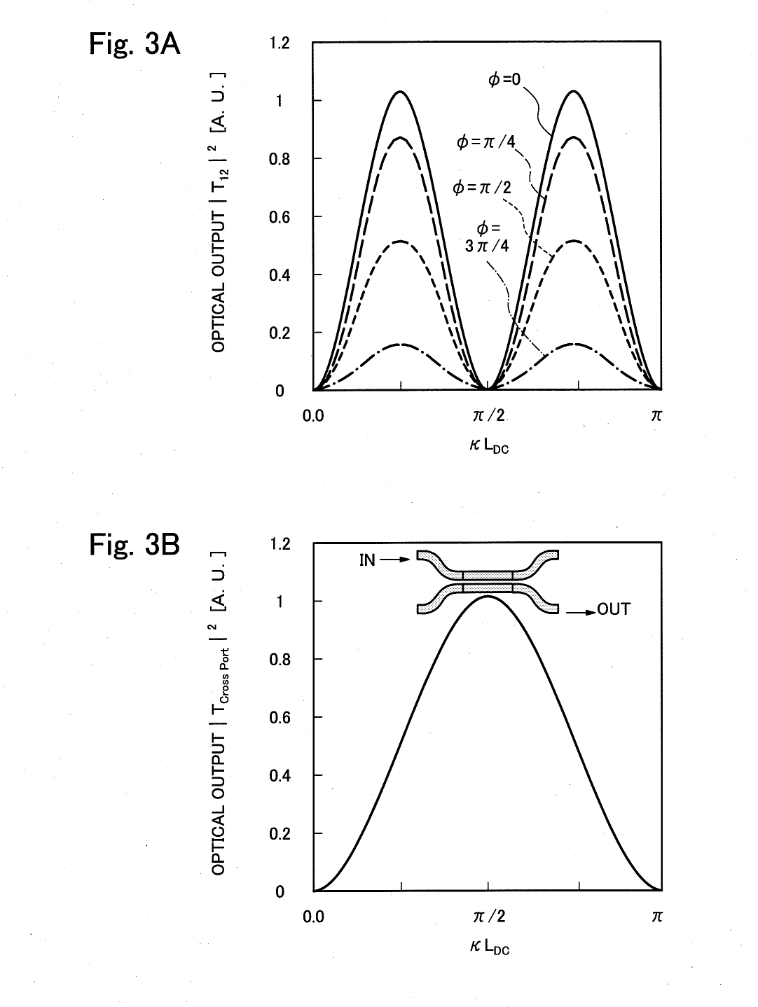

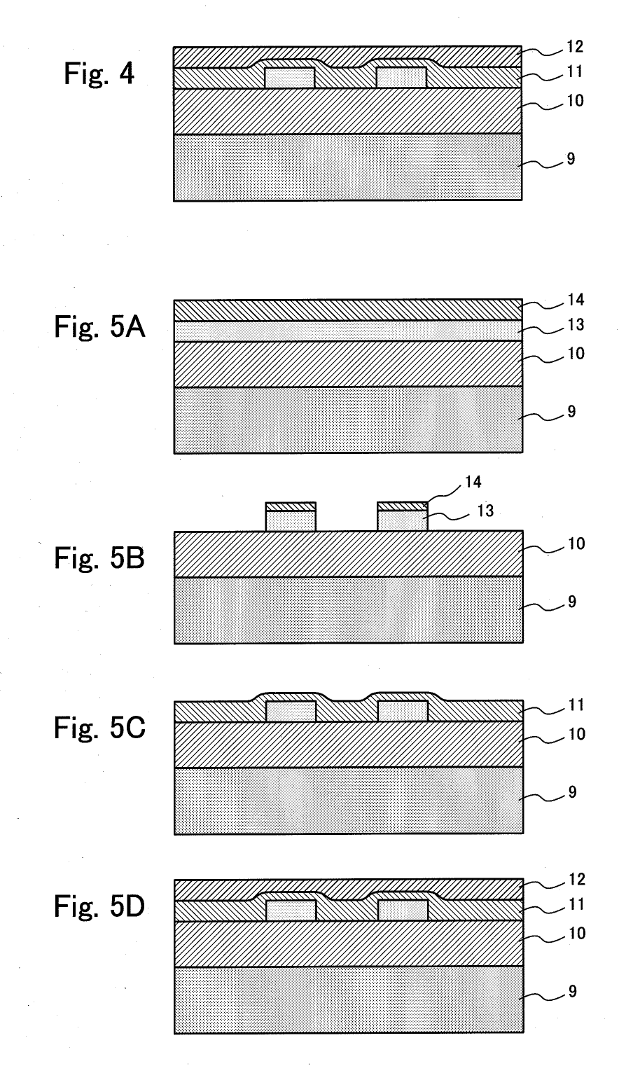

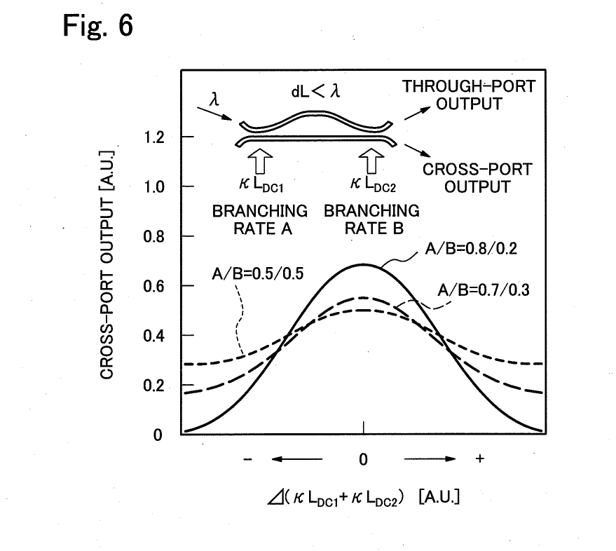

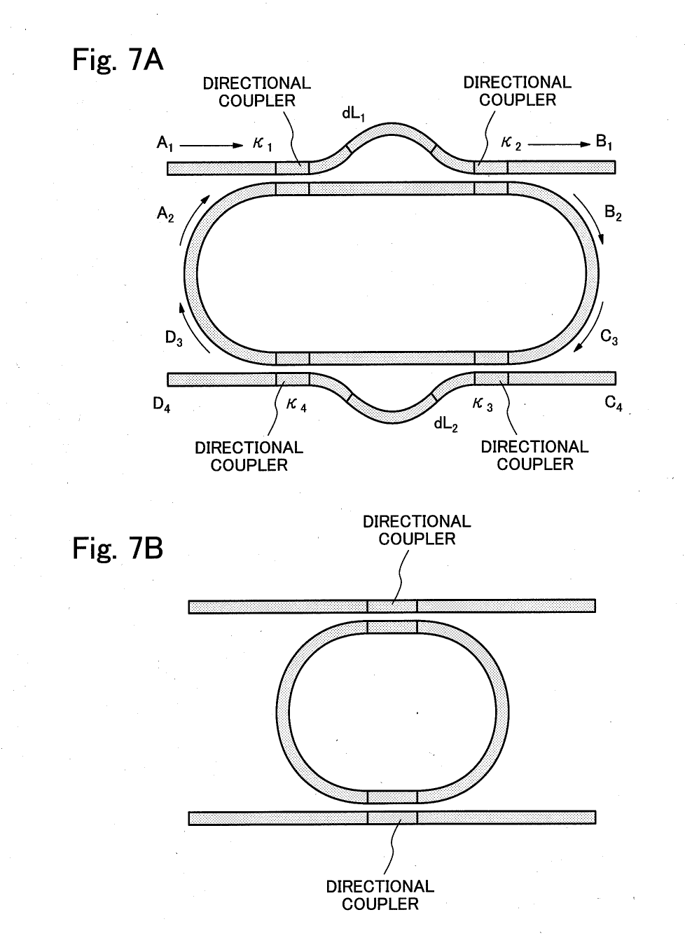

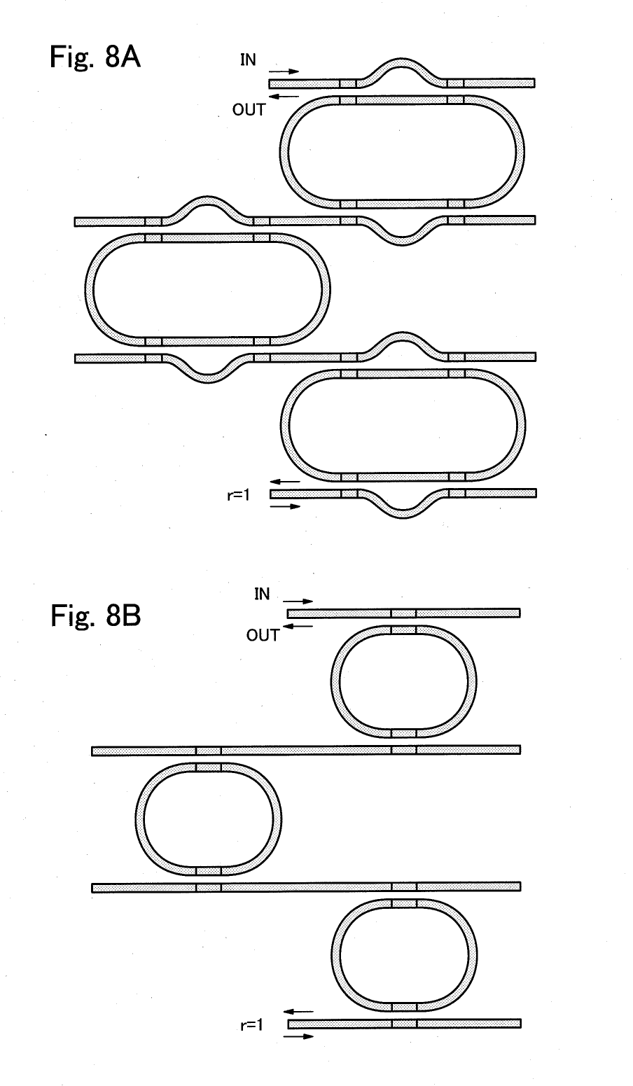

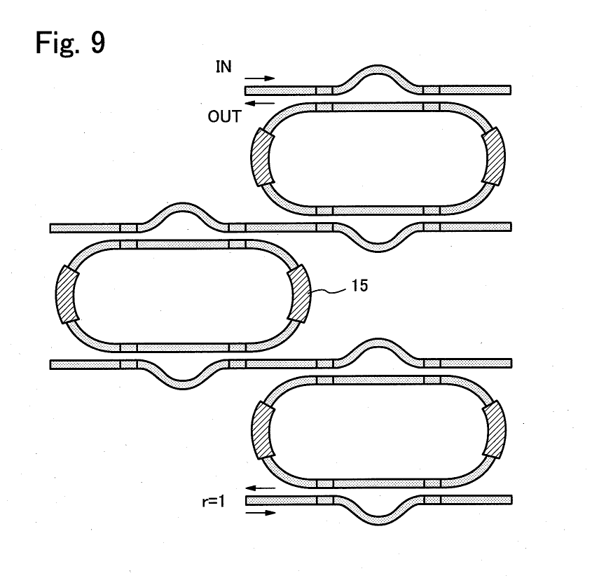

### BRIEF DESCRIPTION OF THE DRAWINGS

[FIG. 1] A top plan view showing a configuration of an optical branching element of a first exemplary embodiment of the present invention.

[FIG. 2A] A schematic diagram showing a first example of optical branching characteristics of an optical branching element of the first exemplary embodiment of the present invention with respect to variation in branching rates of directional couplers constituting the optical branching element, for specific combinations of the branching rates.

[FIG. 2B] A schematic diagram showing a second example of optical branching characteristics of an optical branching element of the first exemplary embodiment of the present invention with respect to variation in branching rates of directional couplers constituting the optical branching element, for specific combinations of the branching rates.

[FIG. 2C] A schematic diagram showing a third example of optical branching characteristics of an optical branching element of the first exemplary embodiment of the present invention with respect to variation in branching rates of directional couplers constituting the optical branching element, for specific combinations of the branching rates.

[FIG. 3A] A characteristics diagram showing variation in a branch light output with κL_{DC} in an optical branching element of a second exemplary embodiment of the present invention.

[FIG. 3B] A characteristics diagram showing variation in a branch light output with κL_{DC} in a conventional directional coupler alone.

[FIG. 4] A cross-sectional view showing a structure of an optical branching element of the second exemplary embodiment of the present invention.

[FIG. 5A] A cross-sectional view showing a manufacturing step of an optical branching element of the second exemplary embodiment of the present invention.

[FIG. 5B] A cross-sectional view showing a manufacturing step of an optical branching element of the second exemplary embodiment of the present invention.

[FIG. 5C] A cross-sectional view showing a manufacturing step of an optical branching element of the second exemplary embodiment of the present invention.

[FIG. 5D] A cross-sectional view showing a manufacturing step of an optical branching element of the second exemplary embodiment of the present invention.

[FIG. 6] A characteristics diagram showing variation in a branch light output with respect to deviations from set values of branching rates of directional couplers constituting an optical branching element of a third exemplary embodiment of the present invention.

[FIG. 7A] A top plan view of a ring resonator type wavelength filter employing an optical branching element of a fourth exemplary embodiment of the present invention.

[FIG. 7B] A top plan view of a ring resonator type wavelength filter employing a conventional directional coupler.

[FIG. 8A] A top plan view of a three-stage ring resonator type wavelength filter employing an optical branching element of a fifth exemplary embodiment of the present invention.

[FIG. 8B] A top plan view of a three-stage ring resonator type wavelength filter employing a conventional directional coupler.

[FIG. 9] A top plan view of a three-stage ring resonator type wavelength filter employing an optical branching element of a sixth exemplary embodiment of the present invention and having a thin film heater arranged at a ring resonator portion.

### DESCRIPTION OF EMBODIMENTS

Next, exemplary embodiments of the present invention will be described with reference to the drawings.

FIG. 1 is a top plan view showing a configuration of a first exemplary embodiment of an optical branching element of the present invention. This optical branching element comprises a first optical waveguide 1 and a second optical waveguide 2 which are paralleled to each other and have portions for optical coupling 3 and 6 (that is, portions where the two waveguides optically couples with each other) at two positions. An optical path length difference is set between a portion of the first optical waveguide 4 and a portion of the second optical waveguide 5 both linking the portions for optical coupling 3 and 6. Branching rates α and β respectively of the portions for optical coupling 3 and 6 are set at values in a combination giving a stationary state of variation in optical output from a branch side optical waveguide with respect to variation in the branching rates. Further, optical branching characteristics of the optical branching element is adjusted by the optical path length difference between the portion of the first optical waveguide 4 and the portion of the second optical waveguide 5.

In this exemplary embodiment, by using the above-described combination of α and β, variation in optical branching characteristics of the optical branching element of FIG. 1 can be effectively suppressed even when some amount of variation in values of α and β is caused by manufacturing variability or the like. For example, FIGS. 2A-2C schematically show patterns in each of which variation in output intensity of branch light, which is inputted from an input port 7a and outputted from an output port 8b, with respect to deviations of α and β from set values resides in a stationary state locally. There, taking set values of α and β as references, variation in output intensity of branch light is shown with respect to Δ(α+β), which is the amount of deviation of α and β from set values. The deviation amount Δ(α+β) is defined as a total of a deviation of α and that of β each from the respective set values, and assumed is a case where both of the deviations take place in the same amount in the same direction, of either increasing (+) or decreasing (−). As shown in FIGS. 2A-2C, optical branching characteristics of the optical branching element shown in FIG. 1 vary in a variety of manners with respect to a combination of values of α and β, and as in the case of the point a in FIG. 2A, optical branching characteristics of the optical branching element usually vary a lot with a slight variation in values of α and β. However, when preset values of α and β are set at values in a specific combination corresponding to any one of the points b in FIG. 2A, c in FIG. 2B and d in FIG. 2C, optical branching characteristics of the optical branching element vary very little even when some amount of variation takes place in values of α and β.

Here, optical branching characteristics of this optical branching element can be set optionally by adjusting an optical path length difference between the portion of the first optical waveguide 4 and the portion of the second optical waveguide 5. That is, through the optical path length difference, giving an optical phase difference between light components each propagating inside the respective waveguides and causing the light components to interfere with each other, intensity of branch light outputted at the output port 8b can be adjusted. Well-controlled production of such an optical path length difference is far easier compared to that of an optical branching rate value of a directional coupler portion, in a fine optical branching element used in optical integrated circuits, and is less influenced by manufacturing variability or the like.

As has been described above, according to the present exemplary embodiment, there can be obtained an optical branching element which offers effective suppression of variation in its optical branching characteristics due to manufacturing variability or the like, and capability of setting an optional optical branching rate, and is thus suitable for use in optical integrated circuits.

Further, also in a case of an optical branching element with a configuration having three or more portions for optical coupling, similarly, as a first step, optical branching rate values of respective portions for optical coupling are set at values in a combination giving a stationary state of variation characteristics of an optical output from an output port with respect to variation in optical branching rate values of the respective portions for optical coupling. Then, optical path length differences at respective linking portions between the portions for optical coupling are set at values giving desired branching characteristics. By setting the respective design parameters in such manners, there can be achieved an optical branching element and an optical branching circuit which have high production tolerance and capability of setting an optional optical branching rate, and is thus suitable for use in optical integrated circuits.

Next, a second exemplary embodiment of the present invention will be described in detail. An optical branching element of the second exemplary embodiment is the same as that shown in FIG. 1 in configuration itself, but is the one where setting of design parameters for suppressing variation in optical branching characteristics due to production variability is performed as follows.

Each of the portions for optical coupling 3 and 6 in the optical branching element shown in FIG. 1 constitutes a directional coupler. Input/output characteristics of this optical branching element can be expressed using a transfer matrix as follows, following a case of an MZI type optical branching element.

$$( \begin{matrix}{T}_{11} & {T}_{21} \\ {T}_{12} & {T}_{22}\end{matrix} ) = ( \begin{matrix}cos κ {L}_{DCount} & - j sin κ {L}_{DCout} \\ - j sin κ {L}_{DCout} & cos κ {L}_{DCout}\end{matrix} ) ( \begin{matrix}{e}^{- j \frac{2 π {n}_{eff}}{λ}} & 0 \\ 0 & 1\end{matrix} ) ( \begin{matrix}cos κ {L}_{DCin} & - j sin κ {L}_{DCin} \\ - j sin κ {L}_{DCin} & cos κ {L}_{DCin}\end{matrix} ) \qquad ( 1 )$$

Here, in equation (1), T₁₁ represents a transfer function from the input port 7a to the output port 8a, T₁₂ from the input port 7a to the output port 8b, T₂₁ from the input port 7b to the output port 8a, and T₂₂ from the input port 7b to the output port 8b, respectively. Here, the transfer function is defined as ratio of input and output light amplitudes with respect to respective ports. Further, κ represents coupling coefficients of the directional couplers 3 and 6, L_{DCin} and L_{DCout} coupling lengths of the directional couplers 3 and 6, respectively, n_{eff} an effective refractive index of the optical waveguides, λ a wavelength of incident light, and dL an optical path length difference between the linking portions 4 and 5. Expanding the equation (1), the transfer functions can be obtained as follows.

$$( \begin{matrix}{T}_{11} & {T}_{21} \\ {T}_{12} & {T}_{22}\end{matrix} ) = ( \begin{matrix}A & B \\ C & D\end{matrix} ) \qquad ( 2 )$$

where A, B, C and D are respectively expressed as,

$$A = cos κ {L}_{DCin} cos κ {L}_{DCout} {e}^{- j \frac{2 π {n}_{eff}}{λ} d L} - sin κ {L}_{DCin} sin κ {L}_{DCout}$$

$$B = - j sin κ {L}_{DCin} cos κ {L}_{DCout} {e}^{- j \frac{2 π {n}_{eff}}{λ} d L} - j cos κ {L}_{DCin} sin κ {L}_{DCout}$$

$$C = - j sin {κ }_{DCout} cos κ {L}_{DCin} {e}^{- j \frac{2 π {n}_{eff}}{λ} d L} - j sin κ {L}_{DCin} cos κ {L}_{DCout}$$

$$D = - sin κ {L}_{DCin} sin κ {L}_{DCout} {e}^{- j \frac{2 π {n}_{eff}}{λ} d L} + cos κ {L}_{DCin} cos κ {L}_{DCout}$$

Accordingly, when assuming that light entering from the input port 7a is branched and exits from the output port 8b and that no light is inputted from the branch side optical waveguide 2, the transfer function from the input port 7a to the output port 8b is expressed as,

$${T}_{12} = - j sin κ {L}_{DCout} cos κ {L}_{DCin} {e}^{- j \frac{2 π {n}_{eff}}{λ} d L} - jsinκ {L}_{DCin} cos κ {L}_{DCout} \qquad ( 3 )$$

Accordingly, the transfer function of light intensity is obtained as,

$${\vert {T}_{12} \vert}^{2} = {\vert - j sin κ {L}_{DCout} cos κ {L}_{DCin} {e}^{- j \frac{2 π {n}_{eff}}{λ} d L} - j sin κ {L}_{DCin} cos κ {L}_{DCout} \vert}^{2} \qquad ( 4 )$$

Because an optical branching rate value of the directional coupler corresponds to a value of the product of coupling coefficient κ and coupling length L_{DC}, an optical branching rate of the directional coupler can be set by values of κ and L_{DC}. Here, κ is determined by a gap width between the two waveguides and a leak of light from the two waveguides. FIG. 3A shows calculation results of the equation (4) as a function of κL_{DC}, for a case of a simple configuration where both a value of coupling coefficient κ and that of coupling length L_{DC} are common to the directional couplers 3 and 6. As a reference example for comparison, a calculation result of characteristics of an optical output to a cross-port is shown in FIG. 3B, as a function of κL_{DC}, for a case of a conventional directional coupler alone. Compared to the case of a directional coupler alone, branch light output characteristics of an MZI type optical branching element such as that in FIG. 1 have half the period and show a steep gradient against κL_{DC} in wider range of portions. However, by employing a κL_{DC} value for a point where the branch light output characteristics are in a stationary state as a design value of κL_{DC}, even when a κL_{DC} value fluctuates due to a problem in production accuracy, it is possible to minimize its influence on the optical branching characteristics. In the present case, a value of κL_{DC}=π/4 or κL_{DC}=3π/4 for which a branch light output is at a local maximum, for example, can be employed as a design value of κL_{DC}.

Further, in FIG. 3A, also shown are branch light output characteristics of when a phase change amount in a phase change region φ=2πn_{eff}dL/λ is varied. As shown in FIG. 3A, even if a value of φ is changed, the branch light output characteristics do not vary in a peak position, but vary only in a peak height. Here, φ is a value proportional to an optical path length difference dL, and accordingly, in the present invention, by changing a dL in a phase change region, an optical branching rate can be controlled independently of a value of κL_{DC} of a directional coupler constituting an optical branching element. Accordingly, in an optical branching element according to the present invention, suppression of variability in optical branching characteristics and optional setting of an optical branching rate value can be performed simultaneously.

Next, description will be given of a manufacturing method of an optical branching element shown in FIG. 1. FIG. 4 is a cross-sectional view taken along the line A-A′ of FIG. 1, and FIGS. 5A-5D are its manufacturing procedures. Referring to FIG. 4, a lower cladding layer 10 is formed on a silicon substrate 9, two optical waveguides are arranged on it, and a reflow layer 11 and an upper cladding layer 12 are further provided on the upper surface of the optical waveguide layer. The optical waveguides have a higher refractive index compared to the lower cladding layer 10, the upper cladding layer 12 and the reflow layer 11, and accordingly confinement of light inside the optical waveguides is accomplished there.

This optical branching element is fabricated using semiconductor manufacturing processes. First, as shown in FIG. 5A, an NSG (Non dope Silica Glass) film to be the cladding layer 10 is formed on the silicon substrate 9 using a chemical vapor deposition method with plasma, and then an SiON (silicon oxynitride) film to be an optical waveguide core layer 13 is formed.

After that, a waveguide core pattern is transferred to a photoresist 14 by photolithography, and as shown in FIG. 5B, the optical waveguide core layer 13 is patterned by reactive ion etching. In this stage, gap widths between the two waveguides at the portions constituting the directional couplers 3 and 6 are defined to be 1.25 μm at both of the two portions, for example. Further, in the waveguide portions linking between the directional couplers 3 and 6, that is, the linking portions 4 and 5, the linking portion 4 is given a curvature so as to have an optical path length difference with respect to the linking portion 5. By this optical path length difference, an optical phase difference is induced between light components propagating inside the respective waveguides, and interference takes place between them, which makes it possible to adjust intensity of branch light outputted at the output port 8. In setting the optical path length difference, while an identical interference is obtained periodically with a unit of the periodicity being a length corresponding to a wavelength of incident light to the optical branching element, a size of the optical branching element is minimized when the optical path length difference is set at a value smaller than the incident light wavelength.

After the patterning of waveguide cores, residual resist is removed by O₂ ashing, and a high temperature anneal is performed in nitrogen atmosphere. Then, as shown in FIG. 5C, BPSG (Boron Phosphor Silicate Glass) is formed as the reflow layer 11 by an atmospheric pressure chemical vapor deposition method, and further, this reflow layer 11 is planarized by a high temperature anneal.

Finally, as shown in FIG. 5D, forming BPSG as an upper cladding layer 12 by an atmospheric pressure chemical vapor deposition method, and increasing the film density by a high temperature anneal, a configuration of an optical waveguide is completed.

As conventional semiconductor processes are employed in these optical waveguide formation steps, the optical branching element of the present exemplary embodiment can be produced with conventional technology. Here, the manufacturing procedures shown above are just a set of examples, and materials for the substrate, lower cladding layer, optical waveguide core and upper cladding layer are not limited respectively to silicon, NSG, SiON and BPSG. Any material having sufficient physical strength and causing no adverse effects on the waveguide core and cladding layers can be used as the substrate, and any combination of materials can be used as the waveguide core and cladding layers so long as their refractive indices are different from each other in a degree sufficient to enable confinement of light inside the waveguide. Also, waveguide width of the directional coupler portion (coupling length) and gap width between the two waveguides may be determined as any values enabling an appropriate optical coupling.

According to this second exemplary embodiment, an optical branching element and an optical branching circuit suitable for use in optical integrated circuits can be obtained with a high production tolerance and capability of setting design parameters for setting an optional optical branching ratio by calculation, and can be mass-produced by microfabrication technology employing semiconductor manufacturing processes.

Next, a third exemplary embodiment of the present invention will be described.

While, as in the second exemplary embodiment mentioned above, a combination of optical branching rates giving a suppression effect on variation in optical branching characteristics can be obtained by calculation, it can be determined also according to a typical combination pattern of optical branching rates giving the same effect. As such a pattern, there is a case where optical branching ratios of directional couplers at a second and subsequent stages are set as a value equal to an intensity ratio between light components entering from a preceding stage to respectively the optical waveguide on the side of the input port 1 and the optical waveguide on the side of the input port 2. For example, in the optical branching element of FIG. 1, when an optical branching rate of the first directional coupler 3 is 0.8 (optical branching ratio is 0.8:0.2), an intensity ratio between light components which are produced by branching incident light from the input port 1 and then inputted to respectively the optical waveguide on the side of the input port 1 and the optical waveguide on the side of the input port 2 becomes 0.2:0.8. Accordingly, in this case, a branching ratio of the directional coupler 6 is set at 0.2:0.8, that is, a branching rate at 0.2.

In FIG. 6, for cases where combinations of branching rates α and β respectively of the directional couplers 3 and 6 in FIG. 1 are set respectively at “0.8 and 0.2”, “0.7 and 0.3” and “0.5 and 0.5”, as combination patterns described above, shown are variations in branching characteristics of the optical branching element with respect to deviation from the respective design values. There, shown are variations in intensity of branch light output entering from the input port 1 and exiting from the output port 8 (cross-port).

In the present optical branching element, the optical path length difference dL between the portion of the input side optical waveguide 4 and the branch side optical waveguide 5 is set at a length value shorter than a wavelength λ of incident light.

As for the coupling coefficient κ and coupling length L_{DC}, which are parameters determining an optical branching rate (or, branching ratio) of a directional coupler, the former is far more easily influenced by production accuracy and thus is likely to fluctuate than the latter is. This is because, in contrast to that a value of the coupling coefficient κ depends on processing accuracy of a narrow gap between two waveguides, the coupling length L_{DC} is not of a dimension for which processing accuracy is so serious. Therefore, in designing directional couplers with different branching rates from each other, in order to limit causes of variability in the branching rates, it is desirable to set design values of the coupling coefficients κ at the same value and set the branching rates by changing respective coupling lengths L_{DC}.

From this viewpoint, it is determined in the present optical branching element that setting of optical branching rates of the directional couplers 3 and 6 is performed by changing respective coupling lengths, while setting their coupling coefficients κ at the same value.

Further, the abscissa of FIG. 6 is shown as a deviation of κL_{DC} values of the two directional couplers (that is, κL_{DC1} and κL_{DC2}) from design values. Here, the deviation is defined as a total of deviations of κL_{DC1} and κL_{DC2} from respective design values, and assumed is a case where both of the deviations occur in the same amount in the same direction of either increasing (+) or decreasing (−). On the other hand, the ordinate of FIG. 6 shows variation in optical output intensity from the output port 8b (cross-port) of the optical branching element, as a value corresponding to optical branching characteristics of the whole optical branching element.

As shown in FIG. 6, when optical branching ratios of the two directional couplers are in the aforementioned combinations of values, at a point of zero deviation from the design values, optical output intensity from the output port 8b of the optical branching element is at a peak. Therefore, when optical branching rates of the directional couplers 3 and 6 are set at values in these combinations, even if actual branching rate values fluctuate, a range of variability in optical branching characteristics of the whole optical branching element can be suppressed.

Further, also when the number of directional couplers constituting an optical branching element is three or larger, variability in optical branching characteristics can be suppressed by setting a combination of branching rates in accordance with the above-described patterns. For example, description will be given below of a case of a three-stage directional coupler configuration where one stage of directional coupler is added further to the two-stage optical branching element configuration described above. It is assumed that a setting is made such that branching rates of the first and the second stages, among the three stages, are set respectively at 0.8 and 0.2, and by further adjusting an optical path length difference at the linking portions, input light intensity ratio, in the third stage, between a waveguide on the side of an input port 1 and that on the side of input port 2 is set at 0.6:0.4. In this case, when setting the branching ratio of the third stage at 0.6:0.4, that is, the branching rate at 0.6, a range of variability in optical branching characteristics can be suppressed similarly to the case of the two-stage configuration optical branching element described above.

According to this third exemplary embodiment, without performing any complicated calculation, a combination of optical branch rates giving a suppression effect on variability in optical branching characteristics can be determined in accordance with a typical pattern.

Next, a fourth exemplary embodiment of the present invention will be described.

FIG. 7A is a top plan view showing, as a fourth exemplary embodiment of the present invention, a configuration where an optical branching element of the present invention is applied to a ring resonator type wavelength filter. A conventional ring resonator has a configuration shown in FIG. 7B, where optical branching rates of the two directional coupler portions are easy to fluctuate due to a problem in production accuracy, and accordingly, with this configuration, resonance characteristics of the ring resonator fluctuate, influenced by variability in optical branching characteristics of the directional coupler portions. On the other hand, when these two directional couplers are substituted each with an optical branching element of the present invention as shown in FIG. 7A, variability in optical branching characteristics due to production variability can be suppressed through a setting of branching rates of respective directional couplers, similarly to the first exemplary embodiment described above. Accordingly, in this fourth exemplary embodiment, variation in resonance characteristics of the ring resonator can be effectively suppressed, and thus there is a merit that a ring resonator with a high production tolerance can be obtained.

Next, a fifth exemplary embodiment of the present invention will be described.

FIG. 8A is a top plan view showing, as a fifth exemplary embodiment of the present invention, a configuration of a multi-stage ring resonator which is configured by connecting ring resonators employing a directional coupler of the present invention in a multiple stage manner. Further, FIG. 8B shows a top plan view of a multi-stage ring resonator employing a conventional directional coupler. In both of the cases, assumed is a situation where light is reflected at a termination of a third stage ring resonator and returns to an input side. In a configuration such as that in FIG. 8B where a large number of optical branching elements are used, variabilities in branching characteristics of respective optical branching elements are multiplied with each other, and their total influence on the whole optical output characteristics thus becomes extremely large, and accordingly, suppression of a variability in branching characteristics for each optical branching element becomes very important. When these optical branching elements are substituted each with an optical branching element of the present invention as shown in FIG. 8A, each variability in optical branching characteristics due to production variability can be suppressed through a setting of branching rates of respective directional couplers, similarly to the first and the second exemplary embodiment described above. In this fifth exemplary embodiment, variation in resonance characteristics of a multi-stage ring resonator employing a large number of optical branching elements can be suppressed effectively, and the merit is particularly great.

Next, a sixth exemplary embodiment of the present invention will be described.

FIG. 9 is a top plan view showing a sixth exemplary embodiment of the present invention. While it is possible to use a structure for locally changing a refractive index such as a heater and an electrode concomitantly to a conventional directional coupler, in the present exemplary embodiment, a thin film heater 15 is applied to each ring of a ring resonator configured by connecting ring resonators in a multiple stage manner. Also in this sixth exemplary embodiment, a yield of the whole optical circuit can be tremendously improved by improving a yield of each optical branching element, and as in the fifth exemplary embodiment, the merit is particularly great.

As has been described above, the present invention makes it possible to produce an optical branching element whose optical branching characteristics are insusceptible to production variability. Further, the present invention shows a particularly great merit when it is applied to a ring resonator and furthermore to a multi-stage type ring resonator with a cascade connection and the like. Still further, application of the present invention is not limited to ring resonator type devices but is possible to any situations where an optical branching element is used; that is, all types of optical branching elements including that of branching by a directional coupler, and that of Y-shaped branching, MMI-type branching and MZI-type branching can be replaced with an optical branching element according to the present invention.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2009-235112, filed on Oct. 9, 2009, the disclosure of which is incorporated herein in its entirety by reference.

### REFERENCE SIGNS LIST

1 first optical waveguide

2 second optical waveguide

3 portion for optical coupling (directional coupler)

4 portion of the first optical waveguide (linking section)

5 portion of the second optical waveguide (linking section)

6 portion for optical coupling (directional coupler)

7a, 7b input port

8a, 8b output port

9 silicon substrate

10 lower cladding layer

11 reflow layer

12 upper cladding layer

13 optical waveguide core layer

14 photoresist

15 thin film heater

1. An optical branching element comprising a first and a second optical waveguides which are arranged in parallel to each other and have portions for optical coupling at at least two positions, wherein:
an optical path length difference is set between a portion of said first optical waveguide and a portion of said second optical waveguide both linking said portions for optical coupling; and
values of respective branching rates of said portions for optical coupling are set at values in a combination giving a stationary state of variation in optical output from a branch side optical waveguide with respect to variation in the branching rates.

2. The optical branching element according to claim 1, wherein said optical path length difference is smaller than a wavelength of inputted light.

3. The optical branching element according to claim 1, wherein, among said portions for optical coupling which constitute the optical branching element, branching ratios of a second and subsequent stages of said portions for optical coupling are each set at a value equal to a ratio between light intensities inputted respectively to said first optical waveguide and to said second optical waveguide in a corresponding portion for optical coupling.

4. The optical branching element according to claim 1, wherein values of branching rates of said portions for optical coupling which constitute the optical branching element are adjusted by setting all values of coupling coefficients at an identical value and changing values of coupling lengths independently of each other.

5. An optical branching circuit including a ring resonator, the ring resonator comprising two optical branching elements according to claim 1, wherein an output port from a branch side optical waveguide of a first optical branching element is connected with an input port to an input side optical waveguide of a second optical branching element, and an output port from a branch side optical waveguide of the second optical branching element is connected with an input port to an input side optical waveguide of the first optical branching element.

6. An optical branching circuit including a multiple stage ring resonator, the multiple stage ring resonator comprising at least two ring resonators according to claim 5, wherein an output port of a preceding stage ring resonator is connected with an input port of the subsequent stage ring resonator.

7. A manufacturing method of an optical branching element, the optical branching element comprising a first and a second optical waveguides which are arranged in parallel to each other and have portions for optical coupling at at least two positions, wherein:
setting an optical path length difference between a portion of said first optical waveguide and a portion of said second optical waveguide both linking said portions for optical coupling; and
setting values of respective branching rates of said portions for optical coupling at values in a combination giving a stationary state of variation in optical output from a branch side optical waveguide with respect to variation in the branching rates.

8. The manufacturing method of an optical branching element according to claim 7, wherein said optical path length difference is set at a value smaller than a wavelength of inputted light.

9. The manufacturing method of an optical branching element according to claim 7, wherein, among said portions for optical coupling which constitute the optical branching element, branching ratios of a second and subsequent stages of said portions for optical coupling are each set at a value equal to a ratio between light intensities inputted respectively to said first optical waveguide and to said second optical waveguide in a corresponding portion for optical coupling.

10. The manufacturing method of an optical branching element according to claim 7, wherein values of branching rates of said portions for optical coupling which constitute the optical branching element are adjusted by setting all values of coupling coefficients at an identical value and changing values of coupling lengths independently of each other.

11. A manufacturing method of an optical branching circuit, comprising: providing two optical branching elements produced by the method according to claim 7; and arranging a ring resonator wherein an output port from a branch side optical waveguide of a first optical branching element is connected with an input port to an input side optical waveguide of a second optical branching element, and an output port from a branch side optical waveguide of the second optical branching element is connected with an input port to an input side optical waveguide of the first optical branching element.

12. A manufacturing method of an optical branching circuit, comprising: providing at least two ring resonators produced by the method according to claim 11, and arranging a multiple stage ring resonator wherein an output port of a preceding stage ring resonator is connected with an input port of the subsequent stage ring resonator.
